(19) United States
(12) Patent Application Publication
(10) Pub. No.: US 2018/0328753 A1
(43) Pub. Date: Nov. 15, 2018

(54) LOCAL LOCATION MAPPING METHOD AND SYSTEM

(71) Applicant: Raven Telemetry Inc., Ottawa (CA)

(72) Inventors: Braden Stenning, Ottawa (CA); Martin Cloake, Ottawa (CA)

(73) Assignee: Raven Telemetry Inc., Ottawa (CA)

(21) Appl. No.: 15/973,568

(22) Filed: May 8, 2018

Related U.S. Application Data
(60) Provisional application No. 62/503,648, filed on May 9, 2017.

(51) Int. Cl. G01C 21/36; G01C 21/14; G01C 21/16; G01C 21/08; G01C 21/28

(52) U.S. Cl. CPC G01C 21/3676; G01C 21/14; G01C 21/3688; G01C 21/08; G01C 21/28; G01C 21/165

(57) ABSTRACT

A system and method for creating a map of an environment. By calculating a travel path for the mobile device based on location data and orientation data and searching for at least one path feature on the travel path, path features can be identified and overlayed to constrain the map.

### CROSS-REFERENCE TO RELATED APPLICATIONS

This application claims priority to U.S. provisional patent application Ser. No. 62/503,648 filed May 9, 2017, incorporated by reference herein in its entirety.

### FIELD OF THE INVENTION

The present invention pertains to a local location mapping method and system to create a map from location data and orientation data. In particular, the present system and method use dead reckoning deltas obtained from inertial and orientation sensors to interpolate a travel path using travel path features.

### BACKGROUND

The location of a mobile device in an environment can be determined using many different techniques. In outdoor environments Global Positioning System (GPS) data or cellular base station data can be used to triangulate a device location. Data associated with a wireless access point, such as an 802.11 WiFi access point (i.e., Institute of Electrical and Electronics Engineers' (IEEE) 802.11 standards) or wireless local area network and other signal-based indoor location technologies can also be used for indoor location determination by estimating degradation of signal strength over distance in space from a known location, beacon or anchor node. Another method of device location relies on storing pre-recorded calibration WiFi measurement data (i.e., WiFi fingerprinting) in order to generate a radio frequency (RF) map of a building. Based on the location of either the cellular base station or beacon, the mobile computing device can calculate its exact position using triangulation methods with multiple stationary beacons.

Simultaneous Localization and Mapping (SLAM) is a technique used to construct or update a map of an unknown environment while simultaneously keeping track of an agent's location within it. Generally, SLAM consists of multiple parts: landmark extraction; data association; state estimation; state update and landmark update. SLAM techniques have been used for estimating the poses or position of an electronic device in a space and building a map of an unknown environment. Visual, ultrasound, signal strength or laser scans can also be collected as a mobile device moves through an indoor environment, which can be combined with odometry information to estimate the device trajectory. Overlaying this data can yield a map showing the floor plan of an indoor space and provide a wifi-fingerprint or signal strength map of an environment. Once a map is generated, a user can navigate through the space and locate based on an established beacon strength map.

In an example of indoor localization, U.S. Pat. No. 9,288,632 to Yang et al. describes a device and method for detecting the precise indoor location of a portable wireless device based on a WiFi simultaneous localization and mapping (SLAM) algorithm that implements spatial and temporal coherence. In one implementation, a SLAM algorithm includes WiFi similarities and inertial navigational system (INS) measurement data as location estimates for the spatial and temporal coherences implementations to constitute the WiFi-SLAM algorithm.

In another example of indoor localization, U.S. Pat. No. 9,459,104 to Le Grand describes systems and methods for performing a multi-step approach for map generation and device localizing using data collected by the device and observations of interdependencies between the data using simultaneous localization and mapping (SLAM) optimization in combination with signal strength maps.

In an environment with few or no emittive beacons or visual landmarks from which to localize and no absolute location identifiers there remains a need for localizing a mobile device. There further remains a need for a system and method for generating a map in an unknown environment without anchor nodes, beacons or landmarks.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a local location mapping system and method to create a map from travel trajectory measurements and dead reckoning deltas obtained from inertial and orientation sensors to interpolate a travel path using travel path features.

In an aspect there is provided a method of creating a map of an environment with a mobile device, the method comprising: obtaining a travel trajectory for the mobile device in the environment, the travel trajectory comprising a sequence of poses, each pose comprising location data and orientation data with an associated time stamp; calculating a travel path for the mobile device based on the travel trajectory; identifying at least one path feature on the travel path, the at least one path feature comprising a subset of the sequence of poses in the travel trajectory; and overlaying at least two instances of the at least one identified path feature to calculate a travel path and constrain the map.

In an embodiment, the method comprises obtaining exteroceptive data from the mobile device and using the exteroceptive data to further define each pose. In another embodiment, the exteroceptive data is collected from at least one of a magnetometer, sonar sensor, sound pressure sensor, light sensor, barometer, altimeter, thermometer, microphone, IR sensitive sensor, ultrasonic sensor, radiofrequency sensor, and camera.

In another embodiment, the method further comprises identifying a location of an additional mobile device on the map by: obtaining a travel trajectory for the additional mobile device in the environment; extracting at least one path feature from the travel trajectory of the additional mobile device; and overlaying the extracted at least one path feature of the additional mobile device to the calculated travel path to locate the additional mobile device on a travel path on the map.

In another aspect there is provided a method for localizing a mobile device in a mapped environment, the method comprising: obtaining a travel trajectory for the mobile device in the environment, the travel trajectory comprising a sequence of poses, each pose comprising location data and orientation data with an associated time stamp; calculating a travel path for the mobile device based on the travel trajectory; extracting at least one path feature from the travel path, the at least one path feature comprising a subset of the sequence of poses in the travel trajectory; and searching for a similar path feature in the mapped environment to locate the mobile device in the mapped environment.

In another aspect there is provided a system for creating a map of an environment, the system comprising: a mobile device comprising: an inertial sensor; an orientation sensor; and a clock; a processor for: obtaining a travel trajectory for the mobile device in the environment, the travel trajectory comprising a sequence of poses, each pose comprising location data and orientation data with an associated time stamp, the location data and orientation data obtained from the inertial sensor and orientation sensor; calculating a travel path for the mobile device based on the travel trajectory; identifying at least one path feature on the travel path, the at least one path feature comprising a subset of the sequence of poses in the travel trajectory; and overlaying at least two instances of the at least one identified path feature to calculate a travel path and constrain the map; and a mapping module for generating the map.

In another aspect there is provided a method of creating a map of an environment with a mobile device comprising a translation sensor and an orientation sensor, the method comprising: obtaining a dead reckoning data set for a travel path of the mobile device in the environment, the dead reckoning data set comprising data obtained from the translation sensor and the orientation sensor; calculating a travel path for the mobile device based on the dead reckoning data set, the travel path comprising a series of incremental dead reckoning deltas; searching for at least one path feature on the travel path using the set of dead reckoning deltas; and overlaying any identified path features to constrain the map.

In an embodiment of the method, the translation sensor comprises an accelerometer.

In another embodiment, the orientation sensor comprises one or more gyroscope, compass and magnetometer.

In another embodiment, the at least one path feature has a distinctive sequence of dead reckoning deltas relative to the collected path features, and the method further comprises matching the distinctive sequence of dead reckoning deltas to the environment to constrain the map.

In another embodiment, the method further comprises identifying a location of at least one additional mobile device on the map by: obtaining an additional path feature from a dead reckoning data set for a travel path of the additional mobile device in the environment; extracting at least one path feature from the travel path of the additional mobile device, the travel path feature comprising a series of dead reckoning delta vectors; and overlaying the extracted path features to locate the additional mobile device on the map.

In another embodiment, the method further comprises obtaining geospatial data from one or more anchor node.

In another embodiment, the inertial sensor is in an inertial measurement unit.

In another embodiment, the method further comprises locating at least one asset in the environment.

In another embodiment, the asset comprises an anchor node.

In another aspect there is provided a method for localizing a mobile device in a mapped environment, the mobile device comprising a translation sensor and an orientation sensor, the method comprising: obtaining a dead reckoning data set from the mobile device in the environment; calculating a travel path for the mobile device from the dead reckoning data set, the travel path comprising incremental dead reckoning delta vectors; extracting at least one path feature for the travel path from the dead reckoning delta vectors; and searching for a similar path feature for the environment to locate the mobile device in the mapped environment.

In an embodiment, the method further comprises matching the extracted path feature to a single path feature on a previously created map. In another embodiment, the method further comprises returning the best match to locate the mobile device in the known environment.

In another embodiment, the method further comprises matching the extracted path features to multiple matches; and scoring each of the multiple matches to find the best match. In another embodiment, the method further comprises returning more than one match.

In another embodiment, the method further comprises obtaining additional data from the mobile device via additional sensor readings. In another embodiment, the additional data is an altimeter reading, barometer reading, light meter reading, sound reading, camera, code scanner, conversational interface, user interaction, or anchor node interaction.

In another aspect there is provided a system for creating a map of an environment, the system comprising: a mobile device comprising: a translation sensor; an orientation sensor; and a processor; a computing device capable of automatically: obtaining a dead reckoning data set for a travel path of the mobile device in the environment, the dead reckoning data set comprising data obtained from the translation sensor and the orientation sensor; calculating a travel path for the mobile device based on the dead reckoning data set, the travel path comprising a series of incremental dead reckoning deltas; and searching for at least one path feature on the travel path using the set of dead reckoning deltas; and a mapping module for generating the map.

In another embodiment, the system further comprises a graphical user interface for displaying the map.

### BRIEF DESCRIPTION OF THE FIGURES

For a better understanding of the present invention, as well as other aspects and further features thereof, reference is made to the following description which is to be used in conjunction with the accompanying drawings, where:

FIG. 1A illustrates an example of a mobile device and system configured to collect data to map an environment;

FIG. 1B illustrates a specific example of a mobile device and system configured to collect data to map an environment;

FIG. 2 is a flowchart depicting an example method of calculating a travel path and creating a map for an unknown environment;

FIG. 3 depicts a vector transformation between a fixed reference frame and a reference frame attached to a device or person;

FIG. 4A is a pose graph of the movement of a mobile device through an environment;

FIG. 4B is a representation of a travel feature comprising multiple feature descriptors;

FIG. 5 is a graphical depiction of an inertial frame, a vehicle frame, and a sensor frame;

FIG. 6 is a graphical representation of collected sensor data over time;

FIG. 7 is a graphical representation of a calculated travel path of a mobile device in an environment;

FIG. 8 is a flowchart depicting an example method of calculating a travel path and localization in a known environment;

FIG. 9 is a graph of raw data obtained from a magnetometer, gyroscope and accelerometer in a mobile device;

FIG. 10 is a graph of the received signal strength from multiple anchor nodes in an environment; and

FIG. 11 is an example of an anchor node map with multiple anchor nodes.

### DETAILED DESCRIPTION

The following describes various features and functions of the disclosed system and method with reference to the accompanying figures. In the figures, similar symbols identify similar components, unless context dictates otherwise. The illustrative system and method embodiments described herein are not meant to be limiting. It may be readily understood that certain aspects of the disclosed systems and methods can be arranged and combined in a wide variety of different configurations, all of which are contemplated herein. Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

The term “travel path” as used herein refers to a set of data which taken together provides information on the movement or path of a mobile device in a space. The travel path comprises a sequence of poses that define where the mobile electronic device has traveled through in space. The travel path exists outside of time and represents a path in an environment. Each pose along the travel path comprises the position and orientation of a given point in a reference frame. The travel path can be long, short, and can comprise zero, one, or more path features. The path features can be identified and overlayed with path features extracted from multiple travel paths or travel path fragments to create a local map.

The term “anchor node” as used herein refers to a sensor or emittive device with a known location in an environment. Anchor nodes serve as sensor or emittive device reference points fixed in their respective local reference frames in an environment. Examples of anchor nodes include but are not limited to cell towers, WiFi emitters and/or receivers, radio emitters and/or receivers, near field communication (NFC), user interaction terminals, and visual imagery.

Systems and methods are disclosed herein for using a mobile computing device to map an environment from travel trajectory measurements obtained location data and orientation data collected by the mobile device using dead reckoning. Dead reckoning is the process of calculating the current position of an object in an environment by using a previously determined position, or fix, and advancing that position based upon known or estimated speeds over elapsed time and course. Dead reckoning measurements from inertial and orientation sensors are used to interpolate a travel path using travel path features to create a map of an environment. A trajectory is a time-ordered set of states of a dynamic system. In this case, each state is a pose relative to the previous pose in the trajectory, also referred to as dead reckoning deltas.

Systems and methods are also disclosed for determining a user's location within an environment that has been mapped using an extrapolated travel path. Using dead reckoning in combination with at least one inertial sensor and at least one locational sensor the system can compute a course and distance traveled by a mobile electronic device from a previous position and orientation, also referred to as a pose, and use this information to estimate a current pose. A pose is a position and the associated orientation, and a trajectory is a path comprising a sequence of poses with the associated time information. From a trajectory of a person walking or the movement of a mobile device in an environment, the position, time and speed at which the mobile device moved as well as the duration of movement and stoppage of movement can be ascertained. Precise tracking of movement of individuals or mobile devices in an indoor or outdoor environment according to the present system and method further enables map generation of the environment. In particular, a map of the environment can be created by overlaying patterns of travel, referred to herein as travel paths, over previously collected travel data logs, and a mobile device can be located in a known environment by mapping collected travel or path features onto previously identified travel or path features on the map.

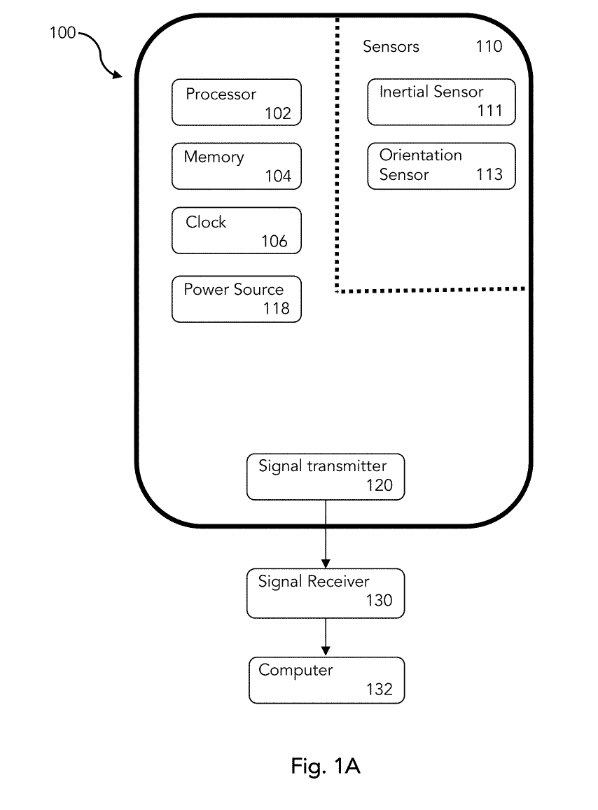

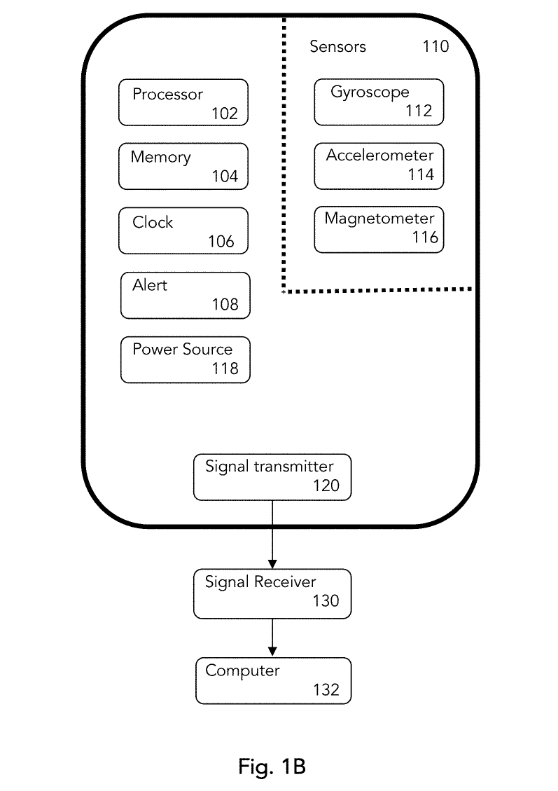

FIG. 1A illustrates an example of a mobile device 100 configured to collect data for mapping an environment. To describe a travel path of a mobile device in an environment, the device movement is sensed and recorded in at least two dimensions: orientation of the mobile device at a time point, and scale of translation between time points. By measuring acceleration and/or velocity, changes in both orientation and translation of the travel path can be interpolated by identifying one or more path features along the travel path. Mobile device 100 comprises at least two sensors 110 capable of collecting translation and orientation information in order to track the movement of the mobile device through space. Inertial sensor 111 can measure both translation and orientation and can be termed an ‘interoceptive’ sensor. The inertial sensor 111 also provides a measurement to obtain a body rate velocity. A single integration over time provides the change in location relative to the reference frame. To capture translation or linear acceleration or rotational acceleration, a double integration of acceleration of the inertial sensor provides a pose delta which can be understood to be a pose in the reference frame during the time that the integration is over. Linear acceleration inertial sensors such as accelerometers give an acceleration in the (x,y,z) frame. The orientation sensor 113 measures body rates in the local reference frame, such as rotational rate around the (x,y,z) axis. One common orientation sensor is a gyroscope. A gyroscope does not measure orientation directly, however can be used to measure the change in orientation over time. Taken together, a common form of a combination inertial sensor and orientation sensor is an inertial measurement unit (IMU).

The inertial and orientation sensors together provide orientational and translational measurements, and provide translation and orientation information to construct the travel trajectory of the mobile device through the environment. Preferably the mobile device also comprises at least one absolute locational or field sensor, also referred to as an exteroceptive sensor, capable of obtaining data on the environment external to the mobile device for additional localization information that can be used to further refine the map. Exteroceptive sensors are used for the observation of the environment or objects around, for example, the mobile electronic device. Some examples of exteroceptive sensors include but are not limited to magnetometers, sonar sensors, sound pressure sensors, light sensors, infrared (IR) sensitive sensors, ultrasonic distance sensors, radiofrequency sensors, thermometers, barometers, altimeters, and microphones. The information and data provided by an exteroceptive sensor in addition to path trajectory data extrapolated by the combination of pose data comprising the translation and orientation between poses can enable more rapid and/or more accurate generation of the travel path.

A translation or inertial sensor may not directly measure translation, instead it may measure signals that can be used to determine translation, e.g. double integration of acceleration over time or single integration of velocity over time to provide a translation. Similarly, the orientation sensor may not directly measure orientation, however the outputs of that sensor can be used to calculate an orientation or a change in orientation. In particular, a combination of inertial sensors to detect changes in rotational attributes like pitch, roll and yaw using one or more gyroscopes in combination with an accelerometer to detect acceleration of the mobile device and an exteroceptive orientation sensor such as, for example, a magnetometer, can provide sufficient data to track the movement of a mobile device through an environment.

In the example mobile device shown in FIG. 1B, sensors 110 comprise a gyroscope 112, accelerometer 114 and magnetometer 116. An accelerometer 114 is an inertial sensor that provides data to estimate distance traveled and 3-dimensional (3D) acceleration data in the frame of the mobile device as it travels through an environment. The accelerometer can be, for example, an angular accelerometer, linear accelerometer, or combination thereof. A gyroscope 112 is an inertial sensor that can be used for estimating changes in orientation and can provide 3D angular velocity in the frame of the mobile device. The gyroscope may either directly measure those orientations, or be a rate gyroscope which measures the body rates and can be used to calculate the orientation. An optional magnetometer 116 measures a magnetic field external to the system and reports that as a vector in a local sensor reference frame. A combination of gyroscope and accelerometer measurements at a single location provide translational acceleration at a given moment while the localized magnetic field vector provides absolute orientation at the same location. Preferably the sensors are combined as an inertial measurement unit (IMU) comprising a combination of one more accelerometer 114 and gyroscope 112, and optionally also a magnetometer 116.

The data obtained from the sensor combination can be used to provide periodic dead reckoning measurements as the mobile electronic device travels through a space. By combining of data from a clock 106 and sensor data, an estimate of how far and in what direction the mobile device has moved in the time period can be calculated. A magnetometer 116 or compass can provide a 3-dimensional magnetic field measurement in the frame of the mobile device. A magnetic field reading by a compass or magnetometer can provide an absolute reference for some of the dimensions of the orientation dimension.

As an alternative to or in addition to a magnetometer, one or more locational beacon or anchor node may be also used to provide an absolute spatial location of the device, and can partially or completely constrain one or more dimensions in one, some or all degrees of freedom. An optional altimeter and/or barometer can provide altitude measurements of the mobile device relative to the earth surface. In a case of a facility with multiple floors having a similar layout, an altimeter can provide vertical location information to differentiate the vertical location of the device. In an environment with one or more anchor nodes, the anchor node may be emitting a radial signal on the ceiling of a lower floor and an altimeter reading can assist in differentiating location on lower or upper floors.

The mobile device can be a handheld device such as a smartphone, tablet, or portable computing device, or wearable device such as, for example, a fob, watch, wristband, jewelery, smart glasses, headsets, augmented reality or virtual reality device, or smart clothing. The mobile device can also be a mobile autonomous or semi-autonomous robot capable of moving through an environment. The mobile device comprises hardware such as a clock 106, memory 104, signal transmitter 120, battery or power system or power supply 118, and a processor 102. Mobile device periodically collects local measurements obtained from the IMU or sensors 110 to obtain the measurements required to determine the travel path. The memory 104 stores data collected from the sensors as the mobile device moves over a plurality of locations during a time period. The mobile device may also connect to a server or computer 132 using a network through a signal transmitter 120 via, for example, a WiFi or radio signal and a signal receiver 130. The mobile device can also comprise a WiFi transceiver, a Bluetooth™ receiver to measure Bluetooth™ low-energy beacons, other wireless receiver, transmitter or transceiver, or a combination thereof.

The mobile device can also be enabled to communicate with the user to provide additional information to the user or enable the user to collect useful information. An optional output or alert means 108 enables messaging from the mobile device to a user, for example to draw the user's attention or to request additional information from the user for the purpose of map generation or localization. The alert means 108 can be a simple output interaction mechanism such as a light or vibration means, or can be more complex such as screen with visual output, or speaker, which can enable and promote interactive localization, or combination thereof. Human interaction alert features can serve multiple purposes, such as advising a user of where to go next, such as checking in at a landmark, or requesting that a user go to a particular place to build the map and/or to improve the quality of the map, for example to complete a loop closure. A user can also be requested to identify where they are on a map by interacting with a landmark or anchor node, and/or by inputting information into the mobile device via a screen, conversational interface, or scanner, which can improve localization and map generation. A request action from the mobile device could be, for example: go to nearest landmark, choose a location on a map via screen, take a photo of the area, return to a landmark or anchor node, turn in a circle, or request for input information, for example to input a code. In this way the mobile device can obtain additional information to locate itself in an environment by obtaining additional input from a person or user which is useful to verify its location in a known or unknown environment.

The mobile device can also be enabled to communicate with a landmark or anchor node in the environment via a transceiver. Optional input/output sensors can also assist in locating the device on a map with a known landmark. Non-limiting examples of such sensors include radio-frequency identification (RFID) scanners, NFC (near field communication) transceivers, speakers, ultrasonic speakers, camera, and light detectors. In one example a landmark or anchor node can ping a nearby mobile device and upon proximity of the device to the anchor node, locate the device relative to the anchor node. Further coordination of the mobile device with a SLAM system or geolocation map can be done via RFID and radio signals. In another example, a microphone on the mobile device can to listen to a tone or pulse from a nearby station emitting a tone, or the mobile device itself can emit a tone for detection by a nearby anchor node. A similar setup can be done using a signal either transmitted or received by the mobile device to/from an anchor node. In another example, a light sensor on the mobile device can pick up data emitted from a light source e.g. a pulse pattern from a light emitting diode (LED). Localization against the ceiling or ground using visual or emittive landmarks and a corresponding camera or data capture means in the mobile device can also be incorporated into the localization. In an example, in a space that has planted landmarks or visual features such as a floor or ceiling image or map, a camera can spatially locate the device by triangulation relative to the stationary visual features. Other sensors can also be used to provide additional data at various states, such as proximity sensors or light sensors to determine, for example, the location of the mobile device on the moving person, such as exposed or in a pocket.

Map Generation

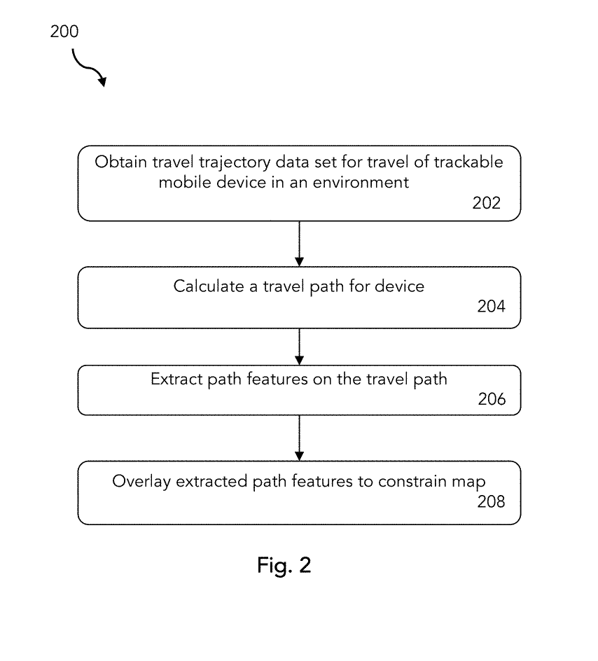

FIG. 2A is a flowchart depicting an example method of calculating a travel path and creating a map for an unknown environment 200. First a travel trajectory data set is obtained for the travel path of the trackable or mobile device in an environment 202. The travel trajectory data set comprises dead reckoning data and can also comprise other orientational or other location data. The travel path is then calculated for the device 204 based on the dead reckoning data set, which is converted into incremental dead reckoning deltas. The travel path comprises a sequence of incremental pose deltas taken together. Data from the sensors may undergo preprocessing at an internal processor in the mobile device. Calculation of the travel path can be done on the device, for example, by on board software on the processor, by extracting data from memory where sensor data has been stored and applying a pre-defined algorithm to estimate the travel path. In another alternative, sensor data collected by the device can be stored in the memory of the mobile device and transmitted or downloaded to a network or external system processor for calculation and travel path determination. In one example, a device such as watch can transmit data to a portable computation device such as a smartphone or computer where the map can be generated. In another example, if the mobile device collecting travel data is a smartphone, the data can be transmitted to a network via WiFi or cellular data connection and data can be processed by a receiving computer to generate the travel path of the mobile device in the environment. In another example, travel data can be processed in part on a processor in the mobile device and in part by an external processor. Creating a map of the environment with a mobile device can be done by one or more internal processors, external processors, or combination of internal processors and external processors.

An extraction of one or more path features along the travel path 206 can be done by calculating fragments of the travel path based on the travel trajectory comprising a string of dead reckoning deltas or sequence of poses, and stitching the poses together to arrive at a segment of the calculated travel path that defines the path feature. The extracted path features can be generalized within an acceptable margin of error such that should the same path feature be recognized as a pattern in a future dead reckoning data set, path features which have vector sections in common can be recognized. Once at least one pair of independently occurring path features has been identified, an overlay of the extracted complementary path features is done to constrain the map 208. By obtaining multiple complementary path features in a data set, such as when one device has traveled along the same path at least twice or when at least two devices have traveled along the same path, the accuracy of the map can be improved. As more data is obtained for each path feature when the travel path is traversed more times, the travel path gets flattened down and the map granularity improves.

A mapping module can be used to generate a local map comprising local path features. In particular, the mapping module builds a travel path on a map that depicts the path of travel of a mobile device through the environment and also delineates where mobile devices are found and not found in the area being mapped. In a preferred embodiment, the parameters being mapped by the mapping module include obstacles through which there is no travel, and clear spaces through which the mobile device is free to navigate. By overlaying the path features for the sections of the travel path which receive most and least traffic, the frequency of movement of particular devices through the environment can also be monitored and mapped.

In an industrial or commercial environment, frequent monitoring of the building environment can be important for security, efficiency or safety reasons. In one example, periodic security checks of areas of interest by a security guard in a building can improve general security monitoring of the building. In particular, if a security guard is found not to be regularly visiting a particular location in the building an alert can be provided to the mobile device advising the security guard to go to that area. In another example, frequent monitoring of industrial or factory environments by a factory floor supervisor is correlated with increased efficiency and safety on the factory floor. By tracking the travel path of a work leader the mobile device can provide an alert of where the work leader needs to visit more or less frequently.

In an environment with a fixed anchor node, proximity data to the fixed anchor node can also be collected by the mobile device along with the dead reckoning measurements collected by the inertial and locational sensors and used as an additional degree of freedom from which a map can be built. The known location of each of anchor node can be stored in the database to enhance or improve the map granularity. In another situation, movable sensor nodes, such as on industrial equipment, can also be tracked in relation to the mapped travel path and the locations of the sensor nodes can be updated to update the local map. In this situation, the locations of the sensor nodes within the mapped reference frame can be periodically updated to create a dynamic map of an environment. Additional information such as the footprint and configuration of the equipment corresponding to each movable sensor node can further enhance map generation by providing obstacle constraints in the environment based on the location and orientation of the movable industrial equipment.

Conventional map data and collected mapping data may be stored in a database operated by a server. The server may comprise or be connected to a computing device capable of storing and maintaining map information and sending and receiving map information using the network. In some examples, the server may connect to an external map database operated by a third party in addition to storing mapping data locally. The server may be also be configured to store and maintain map information obtained from public or proprietary sources. The server may, for example, connect to Google Maps, Google Earth, or any other mapping service to obtain map information stored in those services to tie features of the travel path onto one or more existing maps and to geo-reference generated maps.

Calculation of Travel Path

To calculate a travel path, measurements from an inertial sensor and locational sensor are converted into poses comprising incremental dead reckoning deltas, where each dead reckoning delta comprises the periodic dead reckoning measurements or changes in position and orientation by integrating overtime, and each pose comprises location data and orientation data with an associated time stamp. An interpolation of data from the incremental dead reckoning deltas can provide a vector expression of path features which can be later identified upon successive travel on the same travel path.

The sequences of positions and orientations (also referred to as “poses”) can be used to describe the movement of a moving device with respect to a frame of reference. To calculate a travel path in and map an unknown environment, dead reckoning measurements obtained by the mobile device are converted into incremental dead reckoning deltas. In one implementation the dead reckoning deltas can be used as the path features. In another implementation, the dead reckoning deltas can be used as part of the calculation of the path features and the calculation of travel path and path features can also incorporate other data. The calculation of the travel path does not have to be exclusively based on dead reckoning data and can also use other data to make a better estimate of the travel path. In the simplest case, the travel path and path features are based only on the dead reckoning deltas. Reference frames and transformations enable the localization of the mobile device in space.

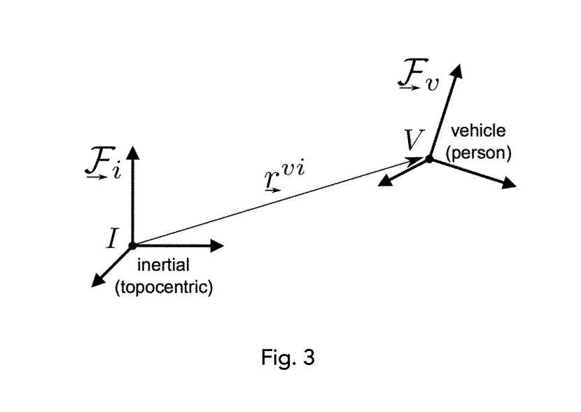

FIG. 3 depicts a vector transformation between a fixed reference frame and a reference frame attached to a device or person. As shown in FIG. 3, the orientation of a person or mobile device (also commonly referred to as a vehicle) can be expressed in the inertial, topocentric frame, wherein the x coordinate roughly points east, y points to the magnetic north, and z is opposite the acceleration due to gravity. Shown are two reference frames, I and V, for the inertial frame and the vehicle frame, respectively. A vector is a quantity having length and direction. Consider the vector [symbol] that points to the vehicle frame from the inertial frame. This vector can be expressed in either of the reference frames

$${r}_{->} = {r}_{i}^{{vi}^{T}} {ℱ}_{-> i} = {{ℱ}^{T}}_{\to i} {r}_{i}^{vi} = {r}_{v}^{{vi}^{T}} {ℱ}_{-> v} = {{ℱ}^{T}}_{-> v} {r}_{v}^{vi}$$

The quantity [symbol] is referred to as a vectrix, and is a matrix that can be thought of as defining the axes of the inertial reference frame. The quantity [symbol] will be a 2×2 matrix when formulating a problem in 2-dimensions, and will be a 3×3 matrix in a 3-dimensional formulation. Similarly, [symbol] defines the axes for the vehicle frame. The quantity rᵢ^{vi} is a column matrix containing the components of the vector to V from I expressed in frame I. Similarly, rᵥ^{vi} contains the components of [symbol] expressed in V. In general, rᵢ^{vi}≠rᵥ^{vi}.

The rotation matrix, often referred to as a direction cosine matrix, is defined as:

Cᵥᵢ=

[symbol]

Rotation matrices possess some special properties. For example:

C₂₁=C₁₂⁻¹=C₁₂^{T}

C₃₁=C₃₂C₂₁

r₁=C₂₁^{T}r₂

Consider a point p which can be written as a point in the vehicle frame as pᵥ. To express the same point in the inertial frame, the transformation to frame V from frame I (or vice versa, because it is invertible) should be determined. One way to express this transformation is the homogeneous transformation; note the form of the homogeneous vector is P_{r,h}:[PᵣI]^{T}, with

$${p}_{i , h} = {T}_{vi}^{i} {p}_{v , h} \\ [ \begin{matrix}{p}_{i} \\ 1\end{matrix} ] = [ \begin{matrix}{C}_{vi}^{T} & - {r}_{i}^{vi} \\ 0 & 1\end{matrix} ] [ \begin{matrix}{p}_{v} \\ 1\end{matrix} ]$$

$${p}_{i} = {C}_{vi}^{T} {p}_{v} - {r}_{i}^{vi}$$

wherein:

α Symbols in this font are real scalars

a Symbols in this font are real column vectors,

A Symbols in this font are real matrices,

(·)ₖ The value of a quality at timestep k

(·)ₖ_{₁}ₖ_{₂} The set of values of a quantity from timestep k₁ to timestep k₂, inclusive

(·)^{x} The cross-product operator which produces a skew-symmetrix matrix from a col

I The identity matrix.

0 The zero matrix.

This calculation enables the expression of the point p in either the inertial or the vehicle reference frame. Given pᵥ, which is the location of point p in the vehicle frame, one can calculate pᵢ, which is the location of point p expressed in the inertial frame. Doing this calculation on a set of points in the vehicle frame and in different vehicle frames, the location of the point p in the inertial frame can be expressed. Each dead reckoning delta can be considered to be a transformation between two poses, and can also be considered to be its own pose for the purposes of path calculation.

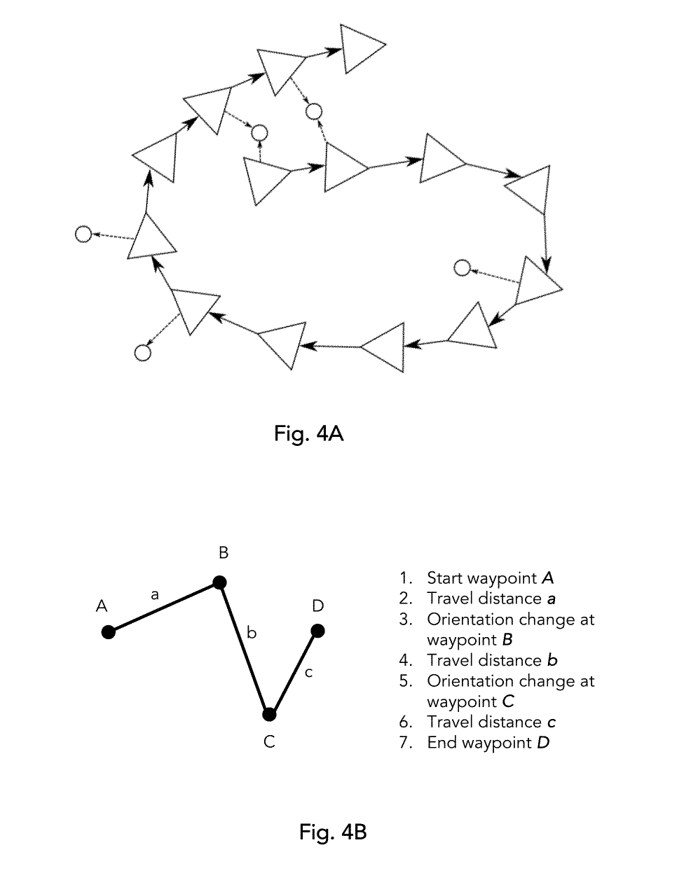

FIG. 4A is a pose graph of the movement of a mobile device through an environment. Nodes in the graph represent poses (Δ), or a location and orientation of a mobile device in an environment at a particular point in time. Edges (shown as arrows between nodes) are transformations between poses. The chain of poses along with timestamps obtained by the clock is a representation of the trajectory or travel path of a mobile device through an environment. Optional landmarks or anchor nodes (O) can be observed when pose data is collected from dead reckoning measurements. Landmarks can also be observed and re-observed to help identify when the mobile device returns to the same location. A determination of when the mobile device returns to the same location can be determined by overlaying the pose patterns comprising a series of feature vectors, to identify corresponding similar travel path features.

FIG. 4B is a representation of a travel path feature comprising multiple path features. Given a travel path from waypoint A to waypoint D, the mobile device extracts dead reckoning measurements at periodic locations along the travel path with each periodic measurement comprising inertial sensor data, locational sensor data and clock data. The feature vector describing a section of the travel path comprises multiple features, where each feature identifies an aspect of the pose or the environment that can be observed along the travel path. In an example, the feature vector can include the translational change in the local x and y directions, the rotational change (θ), beacon signal strength (proximity), magnetic field strength or vector, or other features. The set of features which makes up the feature vector allow the measurement of similarity between two feature vectors and can be used in determining whether those feature vectors represent the same path feature or portion of a travel path. Given a set of feature vectors which have been collected for a particular travel path, the set of feature vectors can be compared to second set of feature vectors to determine whether there is a similarity or common path feature along the travel path.

In the example shown in FIG. 4B, at waypoint A the pose of the mobile device is collected. From waypoint A to waypoint B the mobile device travels a distance a and collects a plurality of feature vectors including incremental dead reckoning deltas. At waypoint B there is an orientation change and the mobile device begins traveling toward waypoint C. After a distance b the mobile device makes another orientation change at waypoint C and travels towards waypoint D for a distance d. The pose at each waypoint, orientation and pose at interstitial points along a straight path and distance between waypoints creates a travel fingerprint which can extracted from the travel path and identified as a travel feature. The pose at each waypoint and the distance between waypoints are feature descriptors which contribute to the overall identification of travel features along the travel path. The next time the same or a different mobile device travels along the same path, the feature vectors including dead reckoning measurements (within a reasonable margin of error) can be extracted such that the commonly travelled travel feature can be overlayed on top of the previously identified travel feature to create a travel map. In one example, a loop closure can be accomplished by identifying corresponding travel features to localize a device in an environment and/or determine that a mobile device is revisiting an already visited location. The number of dead reckoning measurements between waypoints can vary depending on the transit time and/or distance traveled.

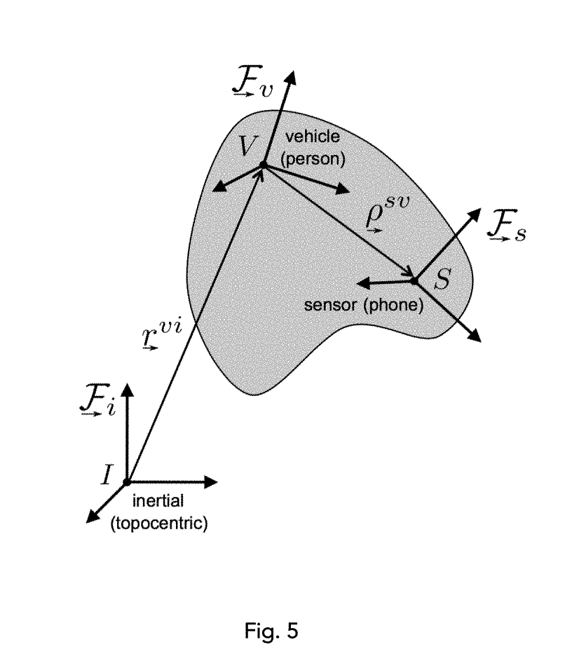

FIG. 5 is a graph of the three main reference frames: the inertial frame, the vehicle frame, and the sensor frame. A set of sensor measurements taken along a travel path at index k can be described as shown below. The movement of the frame of the mobile device or sensor frame is in 3-dimensions, however, the inertial frame and the sensor frame are mostly 2-dimensional. For this nonlinear problem the following motion and observation models can be used:

$$\begin{matrix}motion \text{:} & [ \begin{matrix}{x}_{k} \\ {y}_{k} \\ {θ}_{k}\end{matrix} ] = [ \begin{matrix}{x}_{k - 1} \\ {y}_{k - 1} \\ {θ}_{k - 1}\end{matrix} ] + {T}_{k - 1} [ \begin{matrix}cos {θ}_{k - 1} & - sin {θ}_{k - 1} & 0 \\ sin {θ}_{k - 1} & cos {θ}_{k - 1} & 0 \\ 0 & 0 & 1\end{matrix} ] ( [ \begin{matrix}{v}_{k} \\ 0 \\ {ω}_{k}\end{matrix} ] + {w}_{k} ) \\ observation \text{:} & {r}_{k , i} = {( {x}_{l} - {x}_{k} )}^{2} + {( {y}_{l} - {y}_{k} )}^{2} + {n}_{k , i}\end{matrix}$$

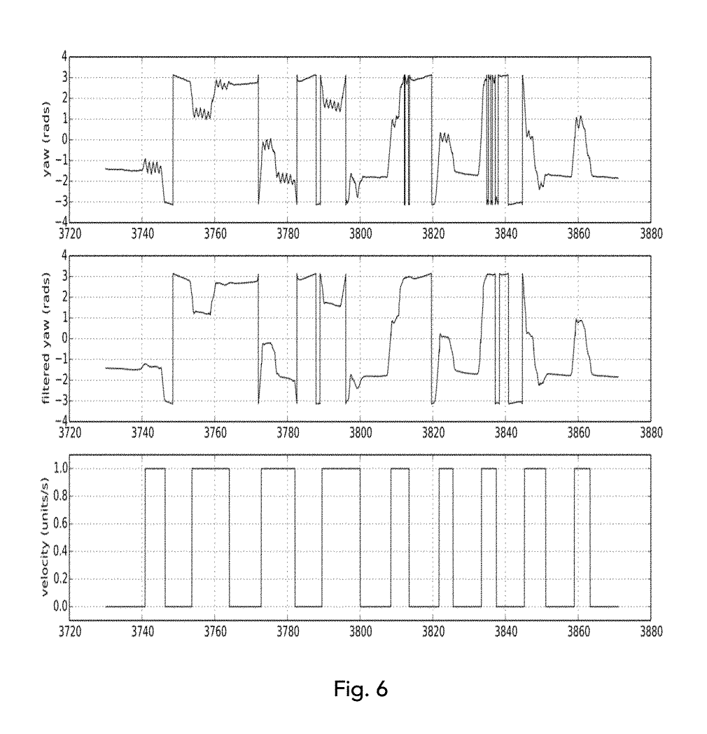

This motion model can be used to develop the method to build a globally consistent model of the travel paths. The motion model can be also used to adjust the map calculation and can also account for external data and noise. The observation model is how measurements can be taken from the environment to estimate a pose at index k, taking into account the estimate of position at k-1. FIG. 6 is an example graph of collected sensor data over time, with yaw, filtered yaw and velocity data. The estimated state can be propagated based on the measurements and the motion model.

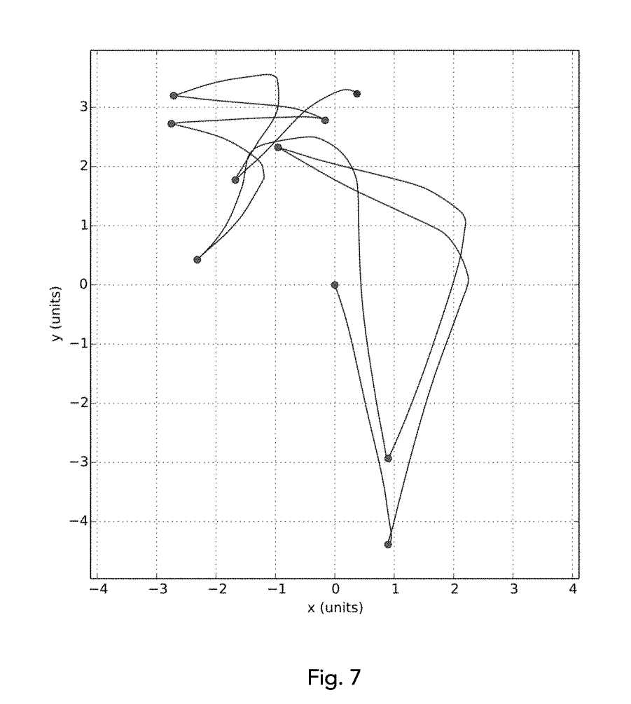

An example of a resulting calculated path based on the combination of location data and orientation data is shown in FIG. 7. A long travel path is shown in FIG. 7, which comprises extracted distinctive features, represented by dots (●). Each dot, which is a location of a distinctive feature vector and has a feature vector and a position of where the dot is estimated to be at. The distinctive features at each dots are compared against the feature vector at other dots to determine the similarity of the feature vectors at various dot locations. Two dots are determined to represent the same location on a map when the similarity between the two distinctive feature vectors is high. The map is then adjusted such that the two dots will lie on top of each other. In a map generation operation, a map can be built by solving an optimization for the travel path to relax the map. In a condition where an attempt is being made to match or locate a mobile device against an existing map, an attempt is made to match the distinctive feature vectors to identify where on the existing map the path fragment lies so that the mobile device can be located on the map. In some cases the identified path feature has a distinctive sequence of features, and the map is constrained by matching the location to a travel path already calculated for the environment which has a high similarity or match of feature vector to constrain the map. In other cases where the identified path feature has similarity to multiple already mapped path features, the path feature can be matched to multiple path feature matches and each of the multiple path feature matches can be scored to identify the best match. As additional data is collected on the travel trajectory, the system can narrow down the potential matches to a single best match.

To identify complementary travel features a Batch Gauss-Newton Optimization can be undertaken. In particular, the following discrete-time, time-invariant motion and observation models can be defined:

motion model: xₖ=h(xₖ₋₁, uₖ, wₖ)

observation model: yₖ=g(xₖ, nₖ)

where k=1 . . . K is the discrete-time index and its maximum.

The noise variables wₖ and nₖ are generalized noise distributions. Gaussian distribution or other distribution may be assumed. The function h(−) is the nonlinear motion model and the function g(−) is the nonlinear observation model. The interoceptive and exteroceptive measurement errors can be defined to be:

e_{k,int}(x):=xₖ−h(xₖ₋₁, uₖ, 0),

e_{k,ext}(x):=yₖ−g(xₖ, 0).

A more compact way of writing the error can be defined as:

$${e}_{k} ( x ) := [ \begin{matrix}{e}_{k , int} ( x ) \\ {e}_{k , ext} ( x )\end{matrix} ] , e ( x ) := [ \begin{matrix}{e}_{1} ( x ) \\ ⋮ \\ {e}_{K} ( x )\end{matrix} ] .$$

Definitions of the Jacobians of the nonlinear motion and observations models are given by:

$${H}_{x , k} := \frac{\partial h ( {x}_{k - 1} , {u}_{k} , {w}_{k} )}{\partial {x}_{k - 1}} {\vert}_{{\tilde{x}}_{k - 1} , {u}_{k} , 0} , \\ {H}_{w , k} := \frac{\partial h ( {x}_{k - 1} , {u}_{k} , {w}_{k} )}{\partial {w}_{k}} {\vert}_{{\tilde{x}}_{k - 1} , {u}_{k} , 0} , and$$

$${G}_{x , k} := \frac{\partial g ( {x}_{k} , {n}_{k} )}{\partial {x}_{k}} {\vert}_{{\tilde{x}}_{k} , 0} , {G}_{n , k} := \frac{\partial g ( {x}_{k} , {n}_{k} )}{\partial {n}_{k}} {\vert}_{{\tilde{x}}_{k} , 0} .$$

So we can define

$$δ x := [ \begin{matrix}δ {x}_{0} \\ δ {x}_{1} \\ ⋮ \\ δ {x}_{K}\end{matrix} ] \cdot H := [ \begin{matrix}- {H}_{x , 1} & 1 & & & \\ & - {G}_{x , 1} & & & \\ & - {H}_{x , 2} & 1 & & \\ & & - {G}_{x , 2} & & \\ & & ⋱ & ⋱ & \\ & & & - {H}_{x , K} & 1 \\ & & & & - {G}_{x , K}\end{matrix} ] , and$$

$$T := [ \begin{matrix}{H}_{w , 1} {Q}_{1} {H}_{w , 1}^{T} & & & & & & \\ & {G}_{n , 1} {R}_{1} {G}_{n , 1}^{T} & & & & & \\ & & {H}_{w , 2} {Q}_{2} {H}_{w , 2}^{T} & & & & \\ & & & {G}_{n , 2} {R}_{2} {G}_{n , 2}^{T} & & & \\ & & & & ⋱ & & \\ & & & & & {H}_{w , K} {Q}_{K} {H}_{w , K}^{T} & \\ & & & & & & {G}_{n , K} {R}_{K} {G}_{n , K}^{T}\end{matrix} ]$$

The Gauss-Newton update is then given by:

(H^{T}T⁻¹H+λD)δx*=−H^{T}T⁻¹e(x̅),

Once the optimal update is computed, ∂x*, the actual update to the design parameter, x̅, is performed, according to:

x̅←x̅+αδx*

where αε[0,1] is a user-definable parameter. Performing a line search for the best value of works well in practice. This works because ∂x* is a descent direction. In this case adjusting for the step direction has been found to be a bit more conservative towards robustness rather than speed. The term x̅ continues updating until δx* is very small.

Mobile Device Localization in a Known Environment

The trajectory of a mobile computing device through an environment can be used to monitor the travel path of a mobile device user and localize a mobile device on an already known map. Monitoring trajectory or path of a person in an environment can assist in, for example, evaluating the performance of that person. The performance of a person whose responsibility it is to frequently monitor locations can be assessed based on their movement patterns in the environment. An example is a security guard who is tasked with ensuring that an indoor environment is monitored frequently. In another example in a manufacturing environment, the monitoring of the manufacturing floor is carried out by a supervisor whose responsibility it is to ensure proper supervision of a section of the factory. Monitoring the supervisor's travel path through the manufacturing floor environment can identify locations of frequent travel and locations of minimal travel. Areas of strength in terms of monitoring can be recognized, while also identifying the areas of their performance that could be improved. Tracking the movement of key individuals on a manufacturing floor provides information about where the individual travelled, and where they did not, and can provide movement maps of people in a local environment. Identifying where leaders spend their time and don't spend their time can help leaders to ensure they are paying attention to all parts of their responsibility domain, assists with escalation chain to identify the location of nearest and available maintenance person as required. Other examples of tracking of mobile devices in an environment may include tracking movement of a mobile device in a retail store to determine which locations in the retail store are more heavily and lightly traveled. Other examples of wider-ranging applications to this technology include but are not limited to indoor or outdoor games, device and traffic movement. A localization module in a mobile device can be used to determine the location of the mobile device traveling through an environment that has already been mapped by extracting the travel path of the mobile device and overlaying it with previously collected travel path data.

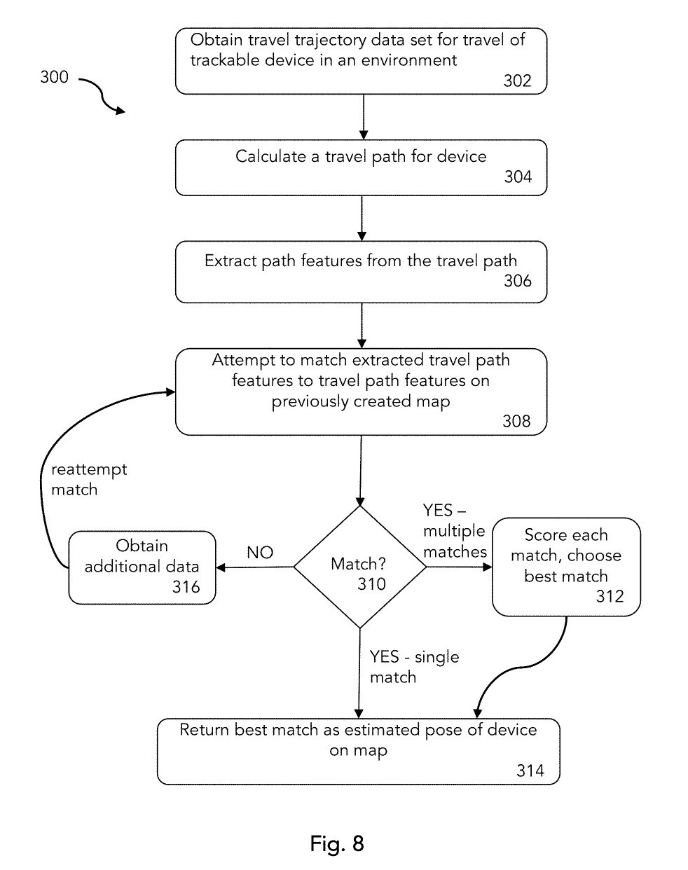

FIG. 8 is a flowchart depicting an example method of calculating a travel path and localization in an known environment 300. At first, a travel trajectory data set is obtained by the mobile device for travel of the trackable device in an environment 302. The travel trajectory data set comprises dead reckoning data and can also comprise other orientational or other location data. The environment may have been previously traveled by the same or different mobile device, and travel path features have already been identified for the environment. Once a sufficient distance has been traveled through the environment, a travel path is calculated for the movement of the device 304 comprising incremental dead reckoning delta vectors. Path features are then extracted from the travel path 306 as described above. An identification of familiar travel features can indicate whether a given location, or a pose associated with a node in a path/trajectory or pose graph, is the same as or similar to one that was previously visited. Once the travel path features of the travel path have been identified, an attempt is made to match the extracted travel path features to travel path features on previously created map 308. The system then inquires if the identified travel feature matches travel features previously identified 310. If the system finds a single match then the system returns the best match as an estimated pose of the device on a map 314. If the system finds multiple matches then each match can be scored to propagate multiple hypotheses regarding the location of the mobile device in the environment during time of uncertainty. If a best match is selected 312, then the best match is returned as a location on a map. One way scoring may be done is by a Mahalanobis distance calculation. If no match is found the mobile device is queued to obtain additional data 316 such that a match can be made in a subsequent travel path extraction. Additional data can be obtained from the mobile device via additional sensor readings, or by asking the user to take data, such as a photograph or light reading, or by requesting that the user identify their location on an existing map. Other additional information can be also be obtained, such as anchor node readings and visual landmarks such as ceiling and floor patterns to provide an additional dimension of data or additional features to locate the mobile device.

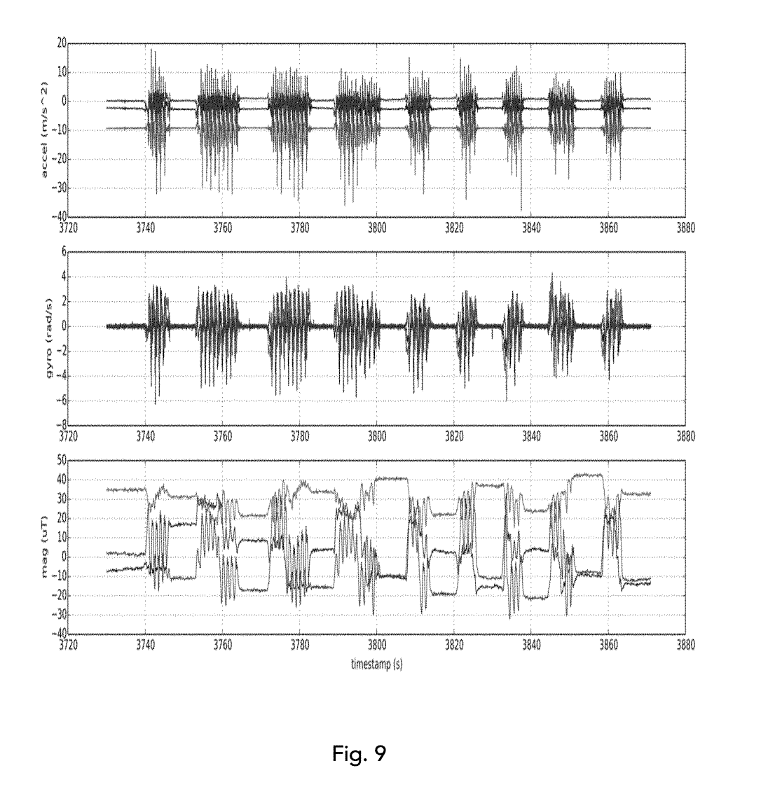

FIG. 9 is a set of graphs of raw data obtained from a magnetometer, gyroscope and accelerometer in a mobile device. Shown are, from top to bottom, linear accelerations in the device's x,y,z coordinate frame, the angular rates around the x,y,z axes of the device's coordinate frame, and the magnetic field vector expressed in the device's x,y,z coordinate frame.

Mapping Including One or More Anchor Nodes

An anchor node can emit a signal to provide its spatial location to a mobile device in the environment to be mapped. A variety of signals can be used, such as cellular signals, Bluetooth™ signals, and other wireless signals. In another example, an anchor node can receive a signal transmitted by the mobile device for localization. In an environment with three or more anchor nodes, a beacon signal map may also be constructed to more precisely locate the trackable device in the environment. In the field of telecommunications, a received signal strength indicator (RSSI) is a measurement of the strength of a wireless signal. Equipment on a manufacturing floor has a unique signature and can also be mapped based on the travel path of the mobile device as well as the known size and mapping equipment. The signature of the asset or equipment can also be triangulated, creating a current map of the factory floor, and compared with movement maps of people in a local environment.

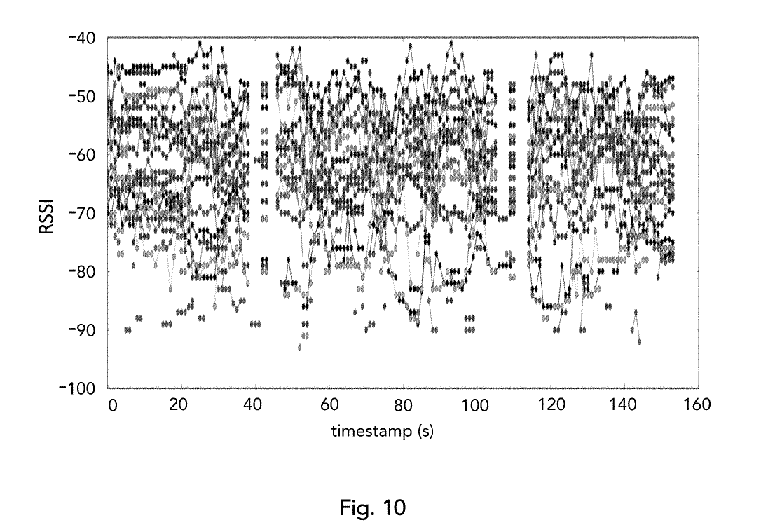

FIG. 10 is a graph of the received signal strength from multiple anchor nodes in an environment. Identifying one or more anchor node signal strengths reduces the search space for a travel path matching in accordance with the present method.

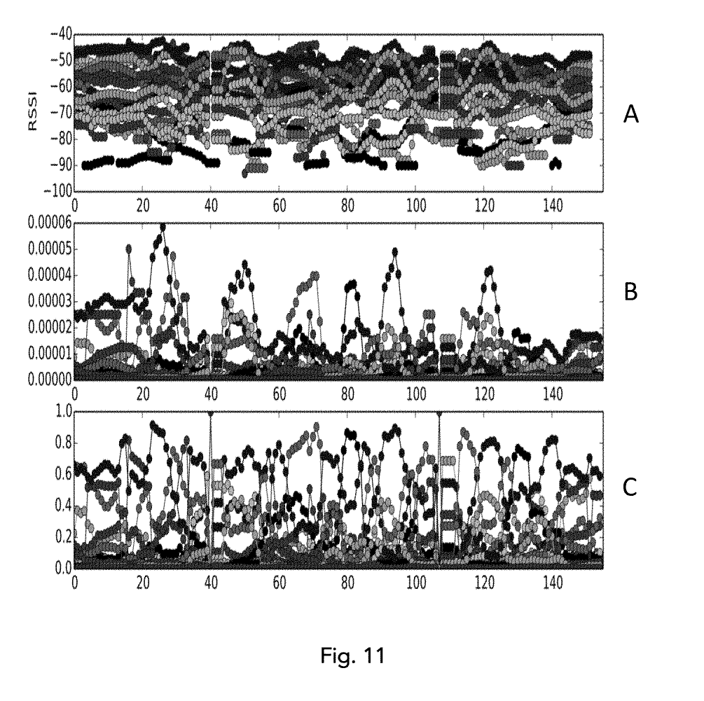

FIG. 11 is an additional example of an anchor node map with multiple anchor nodes. Graph A is a signal strength map where the signal strength is on a logarithmic scale. Graph B is a signal strength map with the signal strength on a linear scale. Graph C is the signal strength graph on a linear scale normalized by the total power received. The anchor node signals with the strongest relative strengths are prioritized. The result is a locational fingerprint that encodes the anchor nodes detectable at a given location. Given a fingerprint of anchor nodes and sensor readings by the mobile device, the possible set of locations of the mobile device can be narrowed down.

In a manufacturing environment, a map can be generated of the plant floor comprising the movement of mobile devices in the environment, optionally also including information from beacons regarding where particular assets are located. The placement of assets such as equipment on the manufacturing floor can further be optimized based on movement of individuals in the environment as well as the size and requirements of the manufacturing assets. A location of a mobile device in a manufacturing environment can be estimated according to a comparison of data available in the logs of data with available known signal strength maps of corresponding data. The first location estimates indicate a trajectory of the device over the time period. Second location estimates of the device location using the first location estimates and relative position estimates of the device based on dead reckoning can also be determined by one or more processors internal or external to the mobile device. Further travel paths of the mobile device along the same path provide a refined trajectory of the device over the time period. The mapping system may also receive wireless signals from wireless devices located in an area and create a wireless signal fingerprint that identifies each signal and the strength of the signal. In a beacon-dense environment with three or more beacons, a geo-referenced map can also be created to provide an absolute location of a trackable device. In an embodiment the mobile device has a wireless signal receiver that is configured to sense various wireless signals for use in determining a location relative to a beacon, or a location fingerprint. A location fingerprint may correspond to, for example, a wireless signal emitter and signal strength from that wireless signal emitter providing an indication of distance from the emitter.

Mapping of assets in a dynamic environment can also be done using the present method and system where the location of assets and physical features changes over time. In dynamic environments comprising a plurality of movable assets, the travel path calculated by mobile devices in the environment can provide data regarding the placement of movable assets and when the assets were moved. When an asset comprises a beacons, the combination of the travel path and beacon signal can update the map of the local environment further utilizing the information known about the asset, such as footprint, to identify the asset on a map.

All publications, patents and patent applications mentioned in this specification are indicative of the level of skill of those skilled in the art to which this invention pertains and are herein incorporated by reference. The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A method of creating a map of an environment with a mobile device, the method comprising:
obtaining a travel trajectory for the mobile device in the environment, the travel trajectory comprising a sequence of poses, each pose comprising location data and orientation data with an associated time stamp;
calculating a travel path for the mobile device based on the travel trajectory;
identifying at least one path feature on the travel path, the at least one path feature comprising a subset of the sequence of poses in the travel trajectory; and
overlaying at least two instances of the at least one identified path feature to calculate a travel path and constrain the map.

2. The method of claim 1, wherein the mobile device comprises an accelerometer and a gyroscope, and the location data and orientation data is calculated from the accelerometer and gyroscope.

3. The method of claim 1, wherein the travel trajectory comprises at least one of velocity data, acceleration data, and a combination thereof.

4. The method of claim 1, wherein the sequence of poses comprises a sequence of dead reckoning deltas that define the travel trajectory.

5. The method of claim 1, wherein the at least one identified path feature has a distinctive sequence of dead reckoning deltas, the method further comprising matching the distinctive sequence of dead reckoning deltas to a travel path already calculated for the environment to constrain the map.

6. The method of claim 1, further comprising obtaining exteroceptive data from the mobile device and using the exteroceptive data to further define each pose.

7. The method of claim 6, wherein the exteroceptive data is collected from at least one of a magnetometer, sonar sensor, sound pressure sensor, light sensor, barometer, altimeter, thermometer, microphone, IR sensitive sensor, ultrasonic distance sensor, radiofrequency sensor, and camera.

8. The method of claim 1, wherein the location data and orientation data is captured by an inertial sensor.

9. The method of claim 8, wherein the inertial sensor is part of an inertial measurement unit.

10. The method of claim 1, further comprising locating the mobile device relative to one or more anchor node.

11. The method of claim 1, further comprising identifying a location of an additional mobile device on the map by:
obtaining a travel trajectory for the additional mobile device in the environment;
extracting at least one path feature from the travel trajectory of the additional mobile device; and
overlaying the extracted at least one path feature of the additional mobile device to the calculated travel path to locate the additional mobile device on a travel path on the map.

12. The method of claim 1, further comprising locating at least one asset in the environment.

13. A method for localizing a mobile device in a mapped environment, the method comprising:
obtaining a travel trajectory for the mobile device in the environment, the travel trajectory comprising a sequence of poses, each pose comprising location data and orientation data with an associated time stamp;
calculating a travel path for the mobile device based on the travel trajectory;
extracting at least one path feature from the travel path, the at least one path feature comprising a subset of the sequence of poses in the travel trajectory; and
searching for a similar path feature in the mapped environment to locate the mobile device in the mapped environment.

14. The method of claim 13, further comprising matching the at least one extracted path feature to a single path feature in the mapped environment.

15. The method of claim 14, further comprising returning a best match of path features to locate the mobile device in the mapped environment.

16. The method of claim 14, further comprising:
matching the extracted path features to multiple path feature matches; and
scoring each of the multiple path feature matches to identify the best match.

17. The method of claim 13, further comprising collecting external locational data, wherein the external locational data is collected using at least one of an altimeter reading, barometer reading, light meter reading, sound reading, camera, code scanner, conversational interface, user interaction, and anchor node interaction.

18. A system for creating a map of an environment, the system comprising:
a mobile device comprising:
an inertial sensor;
an orientation sensor; and
a clock;
a processor for:
obtaining a travel trajectory for the mobile device in the environment, the travel trajectory comprising a sequence of poses, each pose comprising location data and orientation data with an associated time stamp;
calculating a travel path for the mobile device based on the travel trajectory;
identifying at least one path feature on the travel path, the at least one path feature comprising a subset of the sequence of poses in the travel trajectory; and
overlaying at least two instances of the at least one identified path feature to calculate a travel path and constrain the map; and
a mapping module for generating the map.

19. The system of claim 18, further comprising a graphical user interface for displaying the map.

20. The system of claim 18, wherein the orientation sensor is at least one of a gyroscope, compass, or magnetometer.
